(19) United States
(12) Patent Application Publication
(10) Pub. No.: US 2008/0170610 A1
(43) Pub. Date: Jul. 17, 2008

(54) High Speed Serial Test Circuits

(76) Inventor: Marcellus C. Harper, Kaysville, UT (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 12/013,214

(22) Filed: Jan. 11, 2008

Related U.S. Application Data
(60) Provisional application No. 60/880,111, filed on Jan. 11, 2007.

(51) Int. Cl. H04B 3/46; H04B 17/00; H04Q 1/20

(52) U.S. Cl. 375/226

(57) ABSTRACT

A high speed serial testing circuit includes an input port that receives a serial signal; a means for altering the temporal characteristics of the serial signal; a means for altering the amplitude of the serial signal; a high speed analog-to-digital converter configured to receive the serial signal and output digital data representing the serial signal; and a memory module configured to receive and store the digital data. A method of testing high speed serial devices includes connecting an upstream host, a device under test, and a control device to a USB tester; altering the signals provided by the upstream host to test robustness of the device under test; sampling the signals using a analog-to-digital converter and storing the digital data in a memory.

### RELATED APPLICATIONS

This application claims the benefit under 35 U.S.C. § 119(e) of U.S. Provisional Patent Application No. 60/880,111 filed Jan. 11, 2007 entitled “Test Solutions and Methods for Difficult Case Signals Encountered in Automatic Test Equipment.” The afore mentioned application is incorporated herein by reference in its entirety.

### BACKGROUND

Automatic test equipment (ATE) is often used to test a variety of different electronic components. In many cases the electronic components are mounted to a load board, which is a circuit board designed to serve as an interface between the ATE pin electronics card and an electronic component that is being tested. When testing a digital device, measurements can be made of the digital signals produced by the device to characterize the performance of the device under test. Additionally, a variety of digital signals can be input into the device under test to ascertain its robustness. For example, the logic levels of a digital test signal could be varied to test the reliability of the device under test when receiving less than ideal digital signals. In many instances, digital devices must be tested to assure that they meet a certain standard, such as the universal serial bus specification.

### BRIEF DESCRIPTION OF THE DRAWINGS

The accompanying drawings illustrate various embodiments of the principles described herein and are a part of the specification. The illustrated embodiments are merely examples and do not limit the scope of the disclosure.

FIGS. 1A, 1B, and 1C are illustrative diagrams showing various characteristics of digital signals that are commonly measured, according to principles described herein.

FIG. 2 is an illustrative diagram of one exemplary high speed serial testing circuit, according to principles described herein.

FIG. 3 is an illustrative diagram showing one exemplary universal serial bus (USB) tester, according to principles described herein.

FIG. 4 is an illustrative diagram showing a number of exemplary USB testers configured to test a USB hub device, according to principles described herein.

Throughout the drawings, identical reference numbers designate similar, but not necessarily identical, elements.

### DETAILED DESCRIPTION

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

Automatic test equipment (ATE) is often used to test a variety of different electronic components including, but not limited to, integrated circuits (ICs), analog pins, universal serial bus (USB) ports, radio frequency (RF) circuits, differentially paired signal circuitry, and digital pins.

A load board is a circuit board designed to serve as an interface between the pin electronics card (PEC) in automatic test equipment and the device under test (DUT). A load board is also known as an interface board or a DUT board. In some examples, a load board includes a number of components that are used to set up the DUT for correct testing by the ATE, route the test and response signals between the DUT and the ATE, and provide additional test capabilities that the ATE may not be able to provide.

An ideal load board introduces no distortion, noise, delays, nor errors to the testing process of the DUT. This means that an ideal load board is one that does not seem to exist at all, i.e., as if the DUT were directly connected to the ATE. However, all load boards are inherently imperfect and as a result, test results of the DUT may sometimes be skewed or inaccurate.

The automated test equipment may also be used to test devices that require digital input or output. Digital signals, particularly high speed signals, may be adversely affected by a variety of elements contained with the test setup. By way of example and not limitation, the capacitance, impedance, trace layout, and time delay inherent in the test setup may alter the digital signals generated by or delivered to the DUT. These altered signals may make it more difficult to analyze the actual performance of the DUT. To reduce the artifacts introduced by the board, a variety of digital signal test circuitry can be introduced onto the load board. The digital test circuitry on the load board can be placed in significantly closer proximity to the DUT, thereby minimizing undesirable artifacts and increasing the accuracy of the testing.

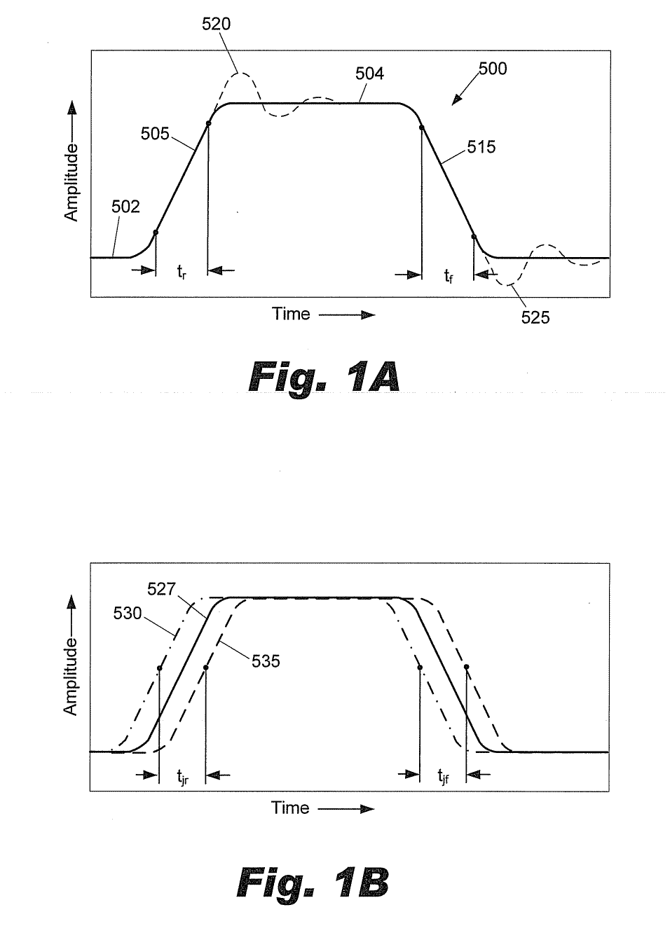

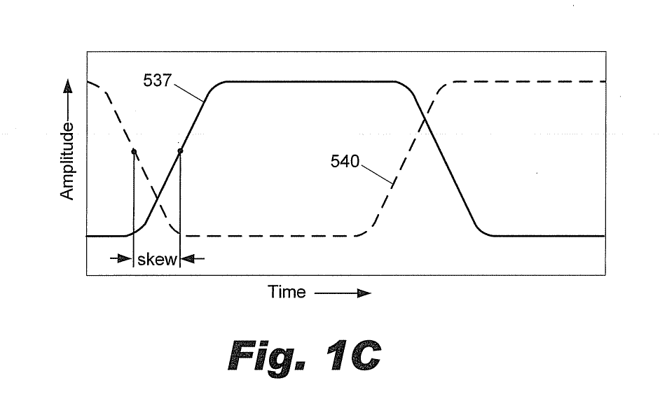

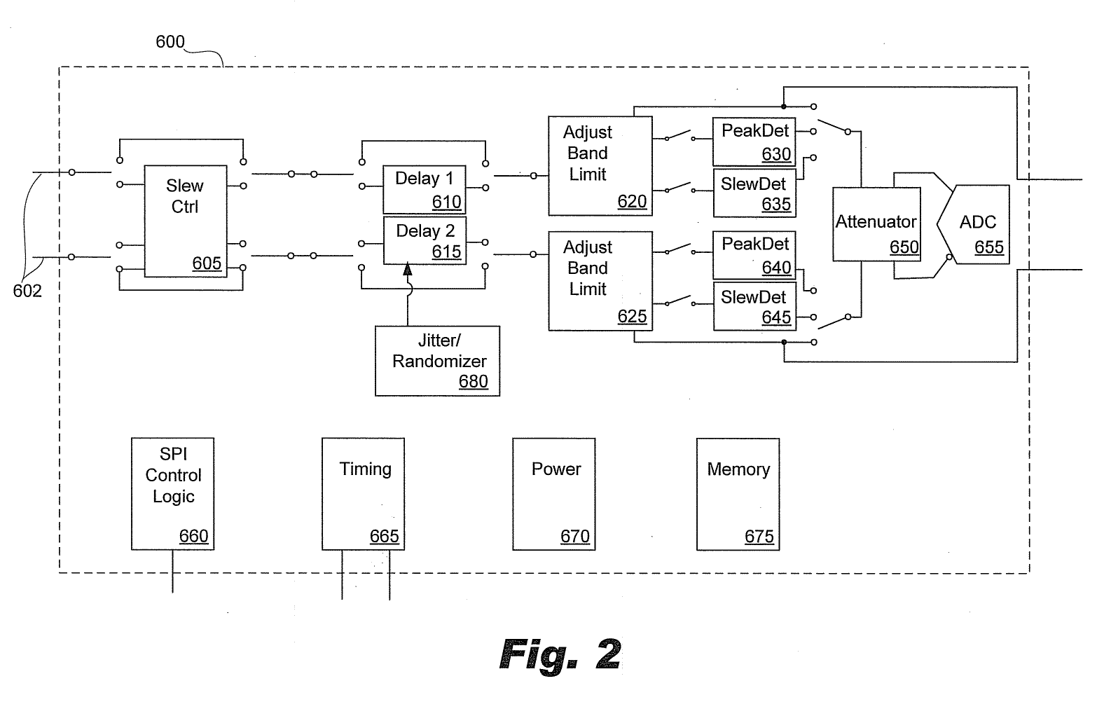

To understand various digital signal parameters that can be tested by circuitry placed on a load board or in another location, several examples of digital signal characteristics are given in FIGS. 1A, 1B, and 1C. FIG. 1A is one exemplary diagram of a digital signal (500). The vertical axis of the graph corresponds to amplitude or voltage changes in the waveform (500). The horizontal axis represents the passage of time, with the most recent portion of the waveform (500) being closest to the vertical axis and the oldest portion of the waveform (500) being the farthest away from the vertical axis. According to one exemplary embodiment, the digital waveform (500) has low amplitude state (502) and high amplitude state (504). The low amplitude state (502) of the waveform (500) may correspond to a digital “0” while the high amplitude state (504) may correspond to a digital “1”. Ideally, the transition between the two states would be instantaneous and without artifacts. However in high speed digital communications, various artifacts are introduced and must be measured and kept within the given parameters for the proper functioning of the system or device.

FIG. 1A shows illustrative examples of several parameters that can be measured when testing digital signals produced by integrated circuits or systems. As the digital signal transitions from its low amplitude state (502) to a higher amplitude state (504), the slope of the rising edge (505) can be measured using a parameter known as “rise time”. In FIG. 1A, the rise time is represented by the variable “tr”. Similarly, the falling edge (515) can be characterized by a parameter “tf” which represents the fall time of the signal between the voltage levels. Additionally, the voltage can overshoot and oscillate as it rises to the higher amplitude level (504). This artifact is represented by an over voltage measurement (520). As the digital signal transitions from the high amplitude level (504) to return to the low amplitude level (502), a corresponding under voltage (525) can occur.

FIG. 1B shows three superimposed digital signals (527, 530, 535). The three waveforms represented in FIG. 1B (527, 530, 535) could be obtained from a variety of sources including successive portions of the same digital signal train or from three different signal sources. Ideally, the three signals (527, 530, 535) would lie directly on top of each other. However, there is a time difference in the generation or reception of the signals. For example, the rising edge of a first signal (535) was received at a time prior to the receipt of the center signal (527) and the third signal (530). The time differences between the receipt of digital signals is called “jitter”. Jitter can be quantified by measuring the elapsed time between the measurement of a characteristic point on a first waveform to a similar characteristic point on a second wave form. In the example shown in FIG. 1B, the jitter on the rising edge is characterized by the variable “tⱼᵣ”. Similarly, on the falling edge jitter can be measured using the variable “t_{jf}”.

FIG. 1C describes the measurement of “skew” between two differential digital channels. Skew is the difference in timing between the two differential signals. Ideally, a second digital signal (540) would be the exact inverse of a first signal (537). However due to time delays or other factors the second signal (540) can be delayed or advanced such that it is not the exact inverse of the first signal (537). This timing error between two signals is called “skew.” In FIG. 1C skew is measured between the center points of the rising edge of the first signal (537) and the center of the falling edge of the second signal (540).

In digital communications these and others parameters can be measured to determine if the signal generating device is functional, compatible with other devices, or meets certain standards. Typically, the higher the frequency of the digital data, the more critical and pronounced various artifacts become.

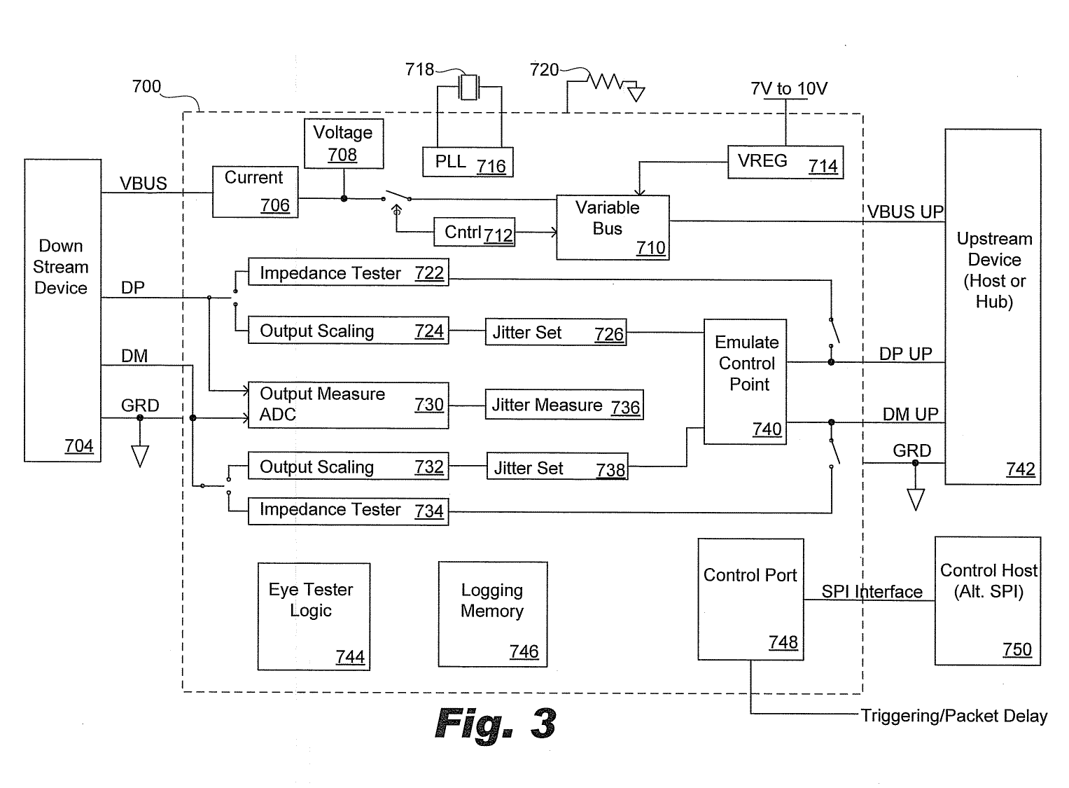

FIG. 2 illustrates an exemplary high speed serial tester (600) that may be used in connection with the systems and methods described herein. Shown in FIG. 2 is a pair of differential channels (602) that are connected to the high speed serial tester (600). The pair of differential channels (602) could be one of multiplicity of differential pair channels. The high speed serial tester (600) may be used to test overshoot, high level, low level, absolute jitter, relative jitter, skew in timing of +/− signals, slew rate of rising/falling edge, and other parameters. The high speed serial tester (600) may also be configured to manipulate the digital signal stream passing through it to test the robustness of a DUT receiving the manipulated signal. The memory module (675) in the high speed serial tester (600) is able to record statistical information that can be used to, but is not limited to, generating eye-plots, recording multiple samples of the aforementioned parameters and producing logs of data for later troubleshooting. Several variations of the high speed serial tester (600) may be used to test dedicated inputs on the DUT, dedicated DUT outputs, or I/O lines.

The high speed serial tester (600) may be comprised of a slew control module (605), delay modules (610, 615), adjust band limit modules (620, 625), peak and slew modules (630, 635, 640, 645), an attenuator (650), and an analog-to-digital converter (655). The pair of differential channels (602) enters the system from the left and proceeds through the modules to the right as shown in FIG. 2. A plurality of switches allow the signals to be directed through a particular unit or around the unit as desired. For example, a switch is located just prior to slew control module (605) which allows each line of the differential channel (602) to be selectively directed through the slew control module (605) or around the slew control module (605) as desired. As can be seen from FIG. 2, similar routes and modules are in each of the differential lines, resulting in symmetry in the components and functions within the high speed serial tester (600).

The slew control module (605) can be used to vary the slope of the rising and falling edges of digital signals introduced into the serial bus tester via the differential lines (602). The delay modules (610, 615) maybe controlled by a jitter/randomizer (680) that introduces systematic or randomized delays to simulate jitter on a single signal or alter skew between separate signals.

The adjust band limit modules (620, 625) condition the signal for analog-to-digital conversion. According to one exemplary embodiment, the adjust band limit modules (620, 625) may include a low pass filter which may reduce higher frequency noise artifacts. The peak and slew modules (630, 635, 640, 645) additionally optimize the signal for analog-to-digital conversion by controlling the slew and peak values of the signals. The attenuator (650) scales the signal to be within the range of the analog-to-digital converter (655).

As can be seen from FIG. 2, the high speed serial tester (600) can be configured in a variety of ways by positioning the internal switches to include or exclude certain modules. In one exemplary embodiment, the switches can be connected in such a way that the signal from the differential pair may bypass all the components except for the adjust band limit module (620, 625) and is then passed through to the output side of the high speed serial tester (600).

The control logic module (660) allows for a user interface to the high speed serial tester (600). According to one exemplary embodiment, the control logic module (660) uses a has a serial peripheral interface that allows an outside user or entity to set switches, jitter/randomizer parameters, download data from memory, and adjust other parameters within the high speed serial bus (600). The timing module (665) synchronizes the processing of data and other actions within the high speed serial tester (600) and provides a timing reference. According to one exemplary embodiment, the timing module (665) may comprise a phase lock loop module and an external crystal frequency reference. A power module (670) supplies power to the various components and, according to one exemplary embodiment, may provide power from 1.8 Volts to 7 Volts. A memory module (675) can be used to store instructions, accumulate data from the analog-to-digital converter, maintain calibration parameters, or serve other memory functions. According to one exemplary embodiment, the memory module (675) is accessible through the SPI control logic module (660) to the user.

Advantages of the high speed serial tester (600) include, but are not limited to, the ability to test physical properties of several popular differential bus formats without having to know the protocol layers. The high speed serial tester (600) may be contained within a single integrated circuit or may comprise a plurality of integrated circuits appropriately connected. The high speed serial tester (600) may also be able to simultaneously measure a multiplicity of differential channels by replicating the components and connecting network described in FIG. 2. Additionally the high speed serial tester (600) is not limited to measuring differential channels, but could be used to measure two or more single ended signals.

In some examples, various embodiments of high speed serial testers may be placed on a load board or other locations to test one or more universal serial bus (USB) enabled DUTs. Ensuring that a DUT meets USB compliance standards requires specialized testing including, but not limited to, eye-testing, level testing, termination measurement, jitter testing, and turn-around time testing. With the proliferation of low cost USB devices and increasing speeds at which digital data is communicated between USB devices, a precise and cost effective USB tester is needed.

FIG. 3 illustrates an exemplary USB tester (700) that may be used to test a USB DUT (704). As shown in FIG. 3, the USB tester (700) may include a number of components. It will be recognized that the components shown in FIG. 3 are merely exemplary and that that the number and type of components within the USB tester (700) may vary as best serves a particular application.

As shown in FIG. 3, the USB tester (700) may include a number of components configured to vary/measure one or more parameters that require certification by the USB standards organization. These parameters may include, but are not limited to, inrush current on the variable bus (VBUS) power supply, ambient current, eye test plot (measures the differential signals to ensure there is a sufficient window of operation), impedance on the signal lines, VBUS voltage level, digital plus/digital minus Skew, jitter, slew rates, and/or any other parameter. Serializer/deserializer (SERDES) testing could also be done with a similar architecture if the analog-to-digital converter (ADC) were configured to be fast enough to generate an eye plot. In this mode, the unit would operate in a largely pass-through mode. An embodiment of this test circuitry includes memory configured to record statistical results of this tester.

The USB tester (700) components are contained within the dotted line of FIG. 3. According to one exemplary embodiment, upstream device (742) is connected to the USB tester (700). The upstream device (742) can connect to the USB tester (700) using a standard USB protocol, including a variable power bus line labeled “VBUS UP”, a data plus line labeled “DUP” a data minus line labeled “DM UP” and a grounded line “GRD”.

Additionally the USB tester (700) may use external references such as an external crystal (718) which is connected to a phase lock loop module (716) internal to the USB tester. The external crystal (718) serves as a frequency reference for the USB tester and may be used in clocking and other functions. A precision external resistor (720) can provide an absolute reference against which internal resistors and other components can be measured. In particular, the external resistor (720) is used to help evaluate the strength of pull downs and pull ups on the data plus (DP) and data minus (DM) lines. The internal resistors that perform the pull down and pull up functions on the data lines are difficult to manufacture to precise absolute values. The external resistor (720) provides a reference against which the values of the internal resistors can be compared. An external voltage source connected to a voltage regulator (714) allows for the variation of current and voltage parameters supplied to the downstream device under test (704).

The VBUS line supplies the power to operate the downstream device. Typically in a USB device the “VBUS” line supplies between 5.25 V and 4.75 V between the “VBUS” line and the “GRD” line. The performance of the downstream device (704) when voltage or current fluctuations are present in power line can be simulated using the voltage regulator (714) and the variable bus module (710). Using these internal components, the voltage supplied to the downstream device (704) can be varied and the response of the downstream device (704) measured. A current measuring module (706) and a voltage measuring module (708) can be placed to measure the amperage and voltage passing through the VBUS line to the downstream device. Using a control module (712), the connection between the upstream host VBUS line in the downstream host VBUS line can be disconnected and reconnected to measure inrush current. Inrush current is the initial current draw of a device as it is starting operation. In some circumstances the inrush current can be significant and draw down the voltage level of the host device. The USB specification places limits on the allowable inrush current for USB devices to prevent a downstream device from causing glitches in the host's internal power.

Similarly the signals passing through the data plus (DP) and data minus (DM) bus lines to the device under test (704) can be manipulated and measured to test the robustness of the device under test (704). By way of example and not limitation, components within the USB tester (700) associated with the data lines may include an impedance tester (722), a jitter set module (726), output scaling (724), emulate control point (740), and other devices.

The jitter set modules (726, 738) can be used to introduce jitter in a single signal train as described in FIG. 1B and/or skew between differential signals as illustrated in FIG. 1C. The output scaling modules (724, 732) can be used to vary the amplitude of the digital signals passed through the USB tester (700) from the host device (742). These modules (726, 738, 724, 732) test the limits of the downstream device (704) in receiving and interpreting less than ideal signals from an upstream device.

An output measurement can be made using an analog-to-digital converter (ADC) (730) which captures the digital signals supplied to or received from the downstream device (704). These captured digital signals can later be retrieved and analyzed to determine, for example, failure points of the downstream device (704). A jitter measure module (736) may also be included which analyzes the digital data produced by the analog-to-digital converter (730). According to one exemplary embodiment, the analog-to-digital converter (730) operates at high frequencies to resolve the USB data signals at high resolution to allow measurements of slew, over-voltage, under-voltage, jitter, skew, or other parameters.

The impedance module (722) varies the opposition to a time varying current within the electrical circuit or signal path. By way of example and not limitation, impedance module (722) may include resistive impedance or reactive impedance by introducing various resistors, inductors, or capacitors into the signal path. The impedance module (722) may be used in both upstream and downstream data communications. In downstream signals, the impedance module (722) may be used to alter the signal received by the downstream device (704) to test its sensitivity and robustness. In upstream signals, the impedance module (722) can be used to test the signal generation capacity of the downstream device (704) when increasing opposition to the digital signals is imposed on its outputs.

The USB tester (700) may also include an eye logic tester (744) and logging memory (746). The eye logic tester (744) may directly produce an eye diagram or other measurement of the differential signals. An eye diagram is a display in which the digital signal or signals are repetitively sampled and superimposed on each other. The resulting pattern is visually analogous to a series of the eyes between a pair of rails. An example of an eye plot is shown in FIG. 1C, where the first signal (537) and second signal (540) are superimposed creating an eye shaped pattern. FIG. 1C illustrates a partial closing of the eye pattern due to skew. Several system performance measures can be derived by analyzing the eye plot. If the signals are too long, too short, poorly synchronized with the system clock, too high, too low, too noisy, or have too much undershoot or overshoot this can be observed from the eye diagram. Distortion of the signal waveform due to noise or interference also appears as a closure of the eye pattern. The eye width may be used as a measure of timing synchronization and jitter effects. An open eye pattern corresponds to minimal signal distortion.

The logging memory (746) could be connected to and retrieve data from a variety of sources including the analog-to-digital converter (730), the jitter measurement module (736), the current measurement module (706), the voltage measurement module (708), the eye tester logic (744), the control port (748), the digital bus lines, or other components.

According to one exemplary embodiment, the control port (748) is connected to the control host (750) by a standard USB, SPI, or other communication interface. Additionally, the control port could be connected to a variety of external triggers and packet delay lines. The control port (748) could make connections (not shown) with a variety of other components internal to the USB tester (700). By way of example and not limitation, the control host (750) could transfer control parameters to the control port (748) which could then pass these parameters into the logging memory (746). Additionally, the control port (748) could directly connect to various modules and switches to control and synchronize the various functions within the USB tester (700).

The USB tester (700) may be embodied within a single chip in some examples. Advantages of the USB tester (700) include, but are not limited to, the fact that no special hardware is needed on the PEC to do a full USB validation. The USB tester (700) may also be used as a general consumer troubleshooting product to display the quality of the USB signal on any given peripheral and also to display the endpoint 0 identifier string, etc.

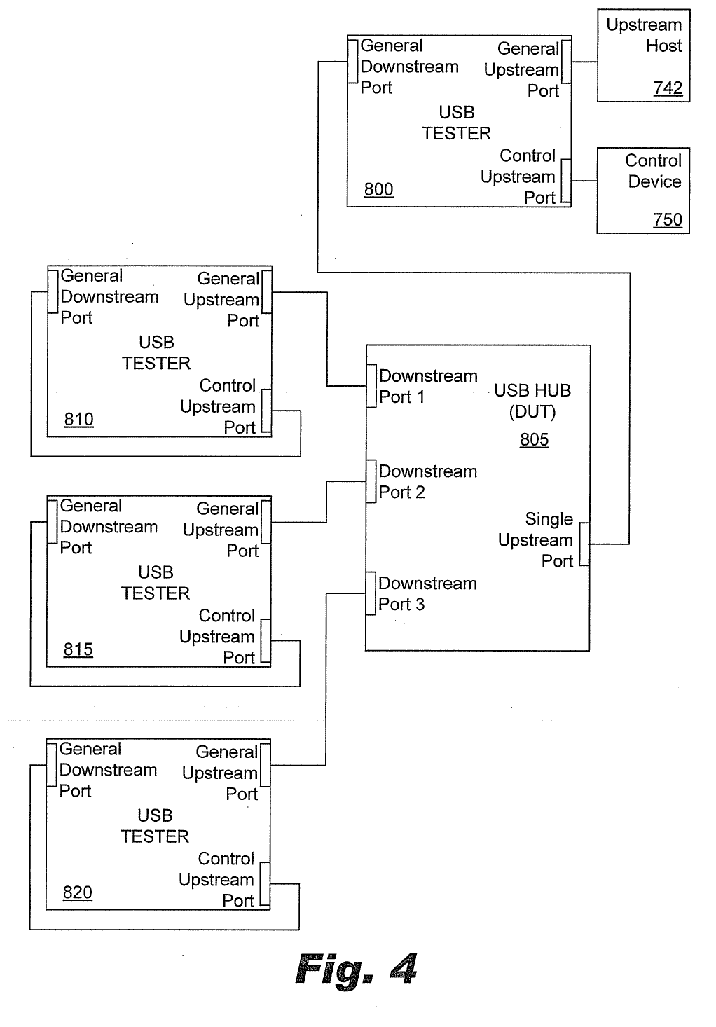

FIG. 4 illustrates a number of exemplary USB testers (800, 810, 815, 820) configured to test a device containing a USB hub (805). As shown in FIG. 4, the ports on the USB tester (800) are broadly described as a general upstream port, control upstream port, and a general downstream port. One exemplary embodiment of these ports is given in FIG. 3, wherein the general upstream port and the general downstream port comprise a standard USB interface. The upstream control port illustrated in FIG. 3 comprises an SPI interface and one or more triggering and packet delay lines.

In FIG. 4, an upstream host (742) is connected to the general upstream port of a USB tester (800) and a control device (750) is connected to the control upstream port. The USB tester (800) is connected to the USB hub (805) which is also the device under test. This connection is made by connecting the downstream port of the USB tester (800) to the single upstream port on the USB hub (805). A first downstream port of the USB hub (805) is connected to the general upstream port of a second USB tester (810). The general downstream port of the second USB tester (810) is connected to the control upstream port of the same USB tester. Additional USB testers (815, 820) are connected to the other downstream ports of the USB hub (805) in a similar manner.

According to one exemplary embodiment, control information and measurement data is passed between the control device (750) and the first USB tester (800). Tests relating to the single upstream port of the USB hub (805) are conducted by the first USB tester (800). However, the USB hub device itself transmits control information to the remaining USB testers (810, 815, 820) via its downstream ports. This control information passes through each downstream USB tester (810, 815, 820) and passes out a general downstream port and returns to the control upstream port of the same USB tester. In this way, control information is passed from the control device (750) to the USB testers (800, 810, 815, 820). Following the receipt of control information, the downstream USB testers (810, 815, 820) conduct tests related to the downstream ports of the USB hub (805). Data from these tests is passed from the control upstream port of each of the down stream USB testers (810, 815, 820) back to the general downstream port of the same tester, out through the upstream port, and into the downstream ports of the USB hub (805). The test data continues through the USB hub (805) and out the single upstream port of the USB hub (805) and into the general downstream port of the first USB tester (800) where it is retrieved via the general upstream port by the upstream host (742) or via the control upstream port by the control device (750). The other configurations using USB testers could be implemented to give test various USB devices and hubs. By way of example and not limitation, USB hubs that have a varying number of downstream ports could be tested by utilizing a corresponding number of USB testers in the configuration illustrated in FIG. 4. In an alternative embodiment, the control device (750) or other similar devices could be attached to the upstream port of each USB tester.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A high speed serial testing circuit comprising:
an input port configured to receive a serial signal;
a means for altering the temporal characteristics of said serial signal;
a means for altering the amplitude of said serial signal;
a high speed analog-to-digital converter configured to receive said serial signal and output digital data representing said serial signal;
a memory module configured to receive and store said digital data; and
a control module; said control module having a external interface;
said external interface allowing a user to input control parameters.

2. The testing circuit of claim 1, wherein said high speed analog-to-digital converter is configured to sub-sample said serial data at resolutions sufficient for the evaluation of skew, jitter, and voltage levels of said serial data.

3. The testing circuit of claim 2, wherein said means for altering the temporal characteristics of said serial signal comprises a jitter/randomizer, said jitter/randomizer configured to impose jitter on said serial signal.

4. The testing circuit of claim 3, wherein said means for altering the amplitude of said serial signal comprise an attenuator module.

5. The testing circuit of claim 4, further comprising an adjust band limit module, said adjust band limit module being configured to reduce noise levels with said serial data.

6. The testing circuit of claim 5, further comprising a slew control module, said slew control module modifying a rising and a falling edge of said serial data.

7. The testing circuit of claim 6, further comprising a device under test connected to said test circuit, said device under test receiving said serial data after said serial data has passed through said test circuit.

8. The testing circuit of claim 7, further comprising an eye logic tester, said eye logic tester being configured to analyze or produce eye diagrams.

9. The testing circuit of claim 2, wherein said testing circuit configured to test universal serial bus devices.

10. The testing circuit of claim 8, wherein said testing circuit further comprises a pass-through mode to passively measure signals.

11. The testing circuit of claim 10, wherein said testing circuit further comprises a means for varying and measuring voltage and current with a voltage supply bus.

12. The testing circuit of claim 11, wherein said means for varying and measuring voltage and current comprises one or more of: a voltage regulator, an inrush switch control module, a current measuring module, and a voltage measuring module.

13. The testing circuit of claim 9, wherein said means for altering said temporal characteristics of said serial signal comprise jitter modules, said jitter modules being configured to introduce skew into said serial signal.

14. The testing circuit of claim 9, further comprising an impedance tester, said impedance tester being configured to test the impedance of a pull-up/pull-down of a universal serial bus node.

15. The testing circuit of claim 9, further comprising an eye logic tester, said eye logic tester being configured to analyze or produce eye diagrams.

16. The testing circuit of claim 9, wherein said testing circuit is externally programmable via a control host.

17. The testing circuit of claim 16, wherein said testing circuit is externally triggerable.

18. The testing circuit of claim 9, wherein said testing circuit is contained within a single integrated circuit, said single integrated circuit being mounted on a load board.

19. The testing circuit of claim 17, wherein a plurality of said testing circuits can be configured to test a universal serial bus hub.

20. A method of testing high speed serial devices comprising:
connecting an upstream host to an upstream port of a USB tester;
connecting a device under test to the downstream port of said USB tester;
connecting a control device to a control upstream port said USB tester;
said USB tester altering signals provided by said upstream host to test robustness of said device under test;
sampling the signals using a analog-to-digital converter; said analog-to-digital converter producing digital data representing said signals;
recording said digital data in a memory.

21. The method of claim 20, wherein said altering said signals includes one or more of: changing line impedance, altering logic levels, changing the supply voltage, introducing temporal aberrations in said signals.

22. The method of claim 21, wherein a plurality of identical USB testers are configured to test a USB hub.
